(19) United States
(12) Patent Application Publication
(10) Pub. No.: US 2008/0101644 A1
(43) Pub. Date: May 1, 2008

(54) Portable electronic device

(75) Inventors: Chi-Jen Yau, Tao Yuan Shien (TW); Chu-Fu Wang, Taipei County (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/896,004

(22) Filed: Aug. 29, 2007

(30) Foreign Application Priority Data
Oct. 31, 2006 (TW) 95219219

(51) Int. Cl. H04R 25/00

(52) U.S. Cl. 381/380; 381/370

(57) ABSTRACT

A portable electronic device including a body and a wireless headset attached to the body is provided. The body includes a headset storage portion located therein and an opening exposing the headset storage portion. The wireless headset is configured to fit in the headset storage portion and cover the opening. The headset storage portion and the opening are located on a corner formed by two adjacent surfaces on the body and the headset storage portion is configured to allow the wireless headset be detached from the body through the opening.

### RELATED APPLICATIONS

This application claims priority to Taiwan Application Serial Number 95219219, filed Oct. 31, 2006, which is herein incorporated by reference.

### BACKGROUND

1. Field of Invention

The present invention relates to a portable electronic device, and more particularly, to a portable electronic device with an attached wireless headset.

2. Description of Related Art

Portable electronic devices, such as mobile phones, personal digital assistants, video game devices and media players have become very popular. Some portable electronic devices may include a wireless headset, such as a Bluetooth headset, an infrared headset or a Wi-Fi headset, to pick up and broadcast sound. However, since conventional wireless headsets cannot be stored in portable electronic devices, users often forget to carry the wireless headset. Indeed, they may even lose the wireless headset.

Thus, it is desirable to provide a portable electronic device with an attached wireless headset in which the wireless headset can be stored in and detached from the portable electronic device.

### SUMMARY

In an aspect of the present invention, a portable electronic device with an attached wireless headset is provided, thus enhancing the carrying convenience for users.

In another aspect of the present invention, a portable electronic device with an attached wireless headset is provided. The portable electronic device is configured to allow the wireless headset be easily detached from the electronic device thereby enhancing the operating convenience for users.

In accordance with an embodiment of the present invention disclosed herein, a portable electronic device including a body and a wireless headset attached to the body is provided. The body includes a headset storage portion located therein and an opening exposing the headset storage portion. The wireless headset is configured to fit in the headset storage portion and cover the opening. The headset storage portion and the opening are located on a corner formed by two adjacent surfaces on the body and the headset storage portion is configured to allow the wireless headset be detached from the body through the opening.

In accordance with an embodiment of the present invention disclosed herein, a portable electronic device including a body and a wireless headset attached to the body is provided. The body includes a headset storage portion located therein and an opening exposing the headset storage portion. The wireless headset is configured to fit in the headset storage portion and covering the opening. The headset storage portion and the opening are located on a corner formed by a front-side surface and a bottom-side surface on the body and the headset storage portion is configured to allow the wireless headset to be detached from the body through the opening. The wireless headset includes a primary portion and an earplug portion coupled pivotally with the primary portion. The primary portion has a second inlet opening located on a second front-side surface coupled with the front-side surface. The earplug portion has an outlet opening located thereon.

According to preferred embodiments of the present invention, the portable electronic device has a wireless headset attached thereto, thus enhancing the carrying convenience for users.

According to preferred embodiments of the present invention, users can push and detach the wireless headset from the body, thus enhancing the operating convenience for users.

According to preferred embodiments of the present invention, the wireless headset can be integrally attached to the body without exposing its structure.

According to preferred embodiments of the present invention, the earplug portion can be turned, thereby decreasing thickness of the wireless headset.

According to preferred embodiments of the present invention, the cost of the portable electronic device can be decreased by utilizing only one microphone built in the wireless headset.

It is to be understood that both the foregoing general description and the following detailed description are by examples and are intended to provide further explanations of the invention as claimed.

### BRIEF DESCRIPTION OF THE DRAWINGS

These and other features, aspects and advantages of the invention will become apparent by reference to the following description and accompanying drawings, which are given by way of illustration only, and thus are not limitative of the invention, wherein:

FIG. 1 is a schematic view of one preferred embodiment of the present invention;

FIG. 2 is a schematic, exploded view of the portable electronic device in FIG. 1;

FIG. 3 is a schematic view of the wireless headset in FIG.1;

FIG. 4 is a schematic view of the wireless headset in operation; and

FIG. 5 is a schematic view of another preferred embodiment of the present invention.

### DESCRIPTION OF THE PREFERRED EMBODIMENTS

The present invention provides a portable electronic device with an attached wireless headset, thereby enhancing the carrying convenience for users. Furthermore, according to preferred embodiments of the present invention, the wireless headset can be easily detached from the portable electronic device, thus improving the users' operating experience.

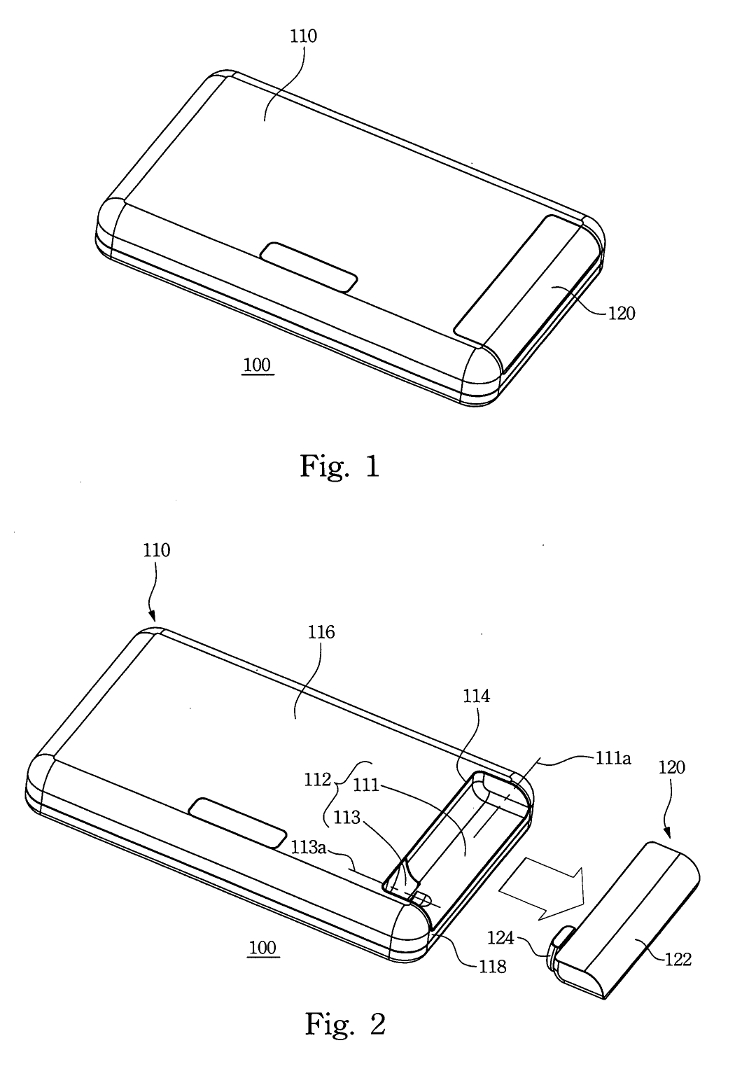

FIG. 1 is a schematic view of one preferred embodiment of the present invention. Referring to FIG. 1, the portable electronic device 100 includes a body 110 and a wireless headset 120 attached to the body 110. FIG. 2 is a schematic, exploded view of the portable electronic device 100 in FIG.1. Referring to FIG. 2, the body 110 has a headset storage portion 112 located therein and an opening 114 exposing the headset storage portion 112. The headset storage portion 112 is configured to store the wireless headset 120. In other words, the wireless headset 120 is configured to fit in the headset storage portion 112 and cover the opening 114, such that users can attach the wireless headset 120 to the body 110, thereby enhancing the carrying convenience.

With continued reference to FIG. 2, the headset storage portion 112 and the opening 114 are located on a corner formed by two adjacent surfaces, for example, a back-side surface 116 and a bottom-side surface 118 on the body 110. Users can push wireless headset 120 out of the corner and detach the wireless headset 120 from the body 110 through the opening 114. Also, the wireless headset 120 can be assembled into the body 110 through the opening 114. The wireless headset 120 is configured to cover the opening 114 and couple with the body 110 integrally. Thus, the wireless headset 120 can be attached to the body 110 without exposing its structure.

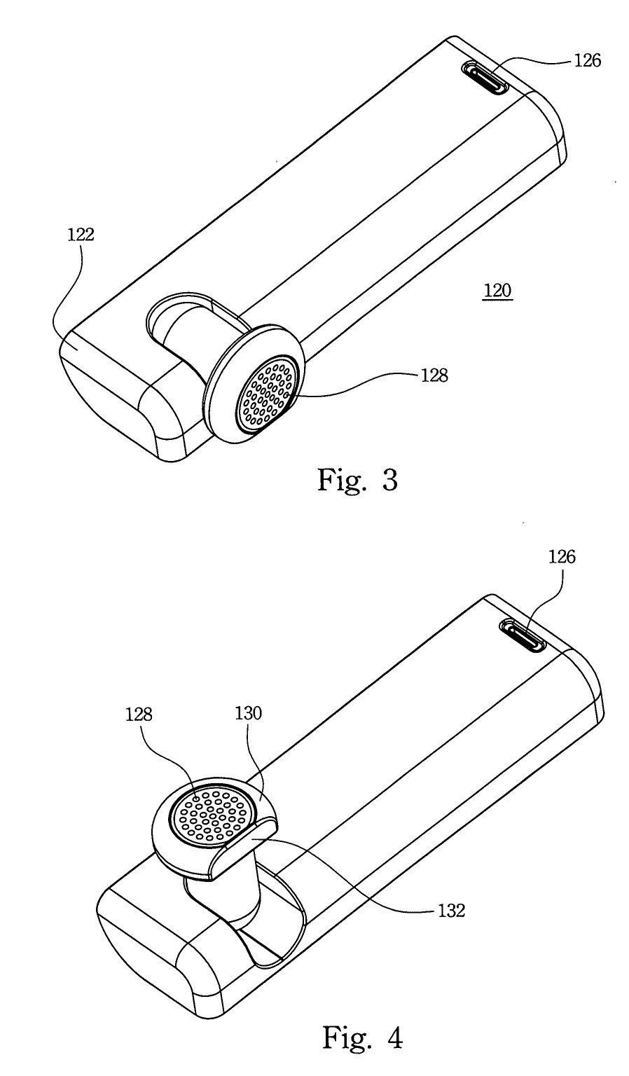

FIG. 3 is a schematic view of the wireless headset 120 in FIG.1. Referring to FIG. 2 and FIG. 3, the wireless headset 120 includes a primary portion 122 with a microphone and an earplug portion 124 with an earpiece. The earplug portion 124 is coupled pivotally with the primary portion 122. The headset storage portion 112 has a first cavity 111 and a second cavity 113 that contains the primary portion 122 and the earplug portion 124 respectively. In an embodiment of the present invention, a first long-axis direction 111a of the first cavity 111 and a second long-axis direction 113a of the second cavity 113 are parallel to the back-side surface 116 of the body 110. An inlet opening 126 is arranged on the primary portion 122 to pick up sound, while at least one outlet opening 128 is arranged on the earplug portion 124 to broadcast sound. The earplug portion 124 can be turned and the directions in which the outlet opening 128 and inlet opening 126 face can be perpendicular to one another. Thus, the wireless headset 120 can be stored in the headset storage portion 112 without increasing the thickness of the body 110.

FIG. 4 is a schematic view of the wireless headset 120 in operation. Referring to FIG. 2 and FIG. 4, the earplug portion 124 pivoted on the primary portion 122 can be turned from 0 degrees to 90 degrees. Thus, the directions in which the outlet opening 128 and the inlet opening 126 face can be parallel to one another. Accordingly, the inlet opening 126 can be turned to face the mouth of a user when the user wears the wireless headset 120. Furthermore, the wireless headset 120 can be worn on either the left or the right ear of a user.

With continued reference to FIG. 4, the earplug portion 124 has a cover 130 located at an end thereof. The cover 130 can be made of soft rubber for ease and comfort of wearing the wireless headset 120. In an embodiment, the cover 130 has a cut plane 132 parallel to a back-side surface 116 of the body 110 to prevent interfering with the body 110.

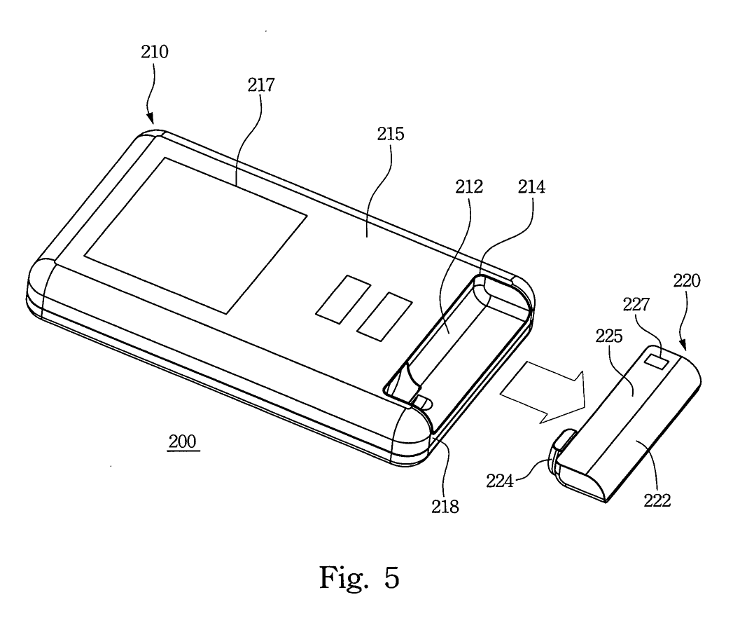

FIG. 5 is a schematic view of another preferred embodiment of the present invention. Referring to FIG. 5, the portable electronic device 200 includes a body 210 and a wireless headset 220 attached to the body 210. The body 210 has a headset storage portion 212 located therein and an opening 214 exposing the headset storage portion 212. The headset storage portion 212 is configured to store the wireless headset 220. The wireless headset 220 can be integrally attached to the body 210, thereby enhancing the carrying convenience for users.

With continued reference to FIG. 5, the headset storage portion 212 and the opening 214 are located on a corner formed by two adjacent surfaces, for example, a front-side surface 215 and a bottom-side surface 218 on the body 210. The wireless headset 220 includes a primary portion 222 and an earplug portion 224 coupled pivotally with the primary portion 222. Users can push wireless headset 220 out of the corner and detach the wireless headset 220 from the body 210 through the opening 214. Also, the wireless headset 220 can be assembled into the body 210 through the opening 214. The wireless headset 220 is configured to cover the opening 214 and couple with the body 210 integrally. Thus, the wireless headset 220 can be integrally attached to the body 210 without exposing its structure.

The body 210 has at least one input/output device 217, for example, a display or a button disposed on the front-side surface 215. The primary portion 222 has a second inlet opening 227 disposed on a second front-side surface 225. The second front-side surface 225 can be coupled with the front-side surface 215. It is worth noting that the primary portion 222 can pick up sound via the second inlet opening 227 when the wireless headset 220 is attached to the body 210. Thus, users can use the wireless headset 220 not only when it is worn on their ears but when it is assembled into the body 210. Accordingly, the cost of the portable electronic device 200 can be decreased since the body 210 need not include any microphone.

According to preferred embodiments of the present invention, the portable electronic device has a wireless headset attached thereto, thus enhancing the carrying convenience for users.

According to preferred embodiments of the present invention, users can push and detach the wireless headset from the body, thus enhancing the operating convenience for users.

According to preferred embodiments of the present invention, the wireless headset can be integrally attached to the body without exposing its structure.

According to preferred embodiments of the present invention, the earplug portion can be turned, thereby decreasing thickness of the wireless headset.

According to preferred embodiments of the present invention, integrating only one microphone into the wireless headset reduces the cost of the portable electronic device.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A portable electronic device comprising:
a body with a headset storage portion located therein and an opening exposing the headset storage portion; and
a wireless headset attached to the body, configured to fit in the headset storage portion and covering the opening,
wherein the headset storage portion and the opening are located on a corner formed by two adjacent surfaces on the body and the headset storage portion is configured to allow the wireless headset to be detached from the body through the opening.

2. A portable electronic device as recited in claim 1, wherein the wireless headset comprises:
a primary portion with an inlet opening located thereon; and
an earplug portion with an outlet opening located thereon, wherein the earplug portion is coupled pivotally with the primary portion.

3. A portable electronic device as recited in claim 2, wherein the headset storage portion comprises:
a first cavity for containing the primary portion; and
a second cavity for containing the earplug portion.

4. A portable electronic device as recited in claim 3, wherein one of the adjacent surfaces is located on a back-side surface of the body, and
wherein the first cavity has a first long-axis direction parallel to the back-side surface; the second cavity has a second long-axis direction parallel to the back-side surface.

5. A portable electronic device as recited in claim 2, wherein the earplug portion has a cover located thereon.

6. A portable electronic device as recited in claim 5, wherein the cover is made of soft rubber.

7. A portable electronic device as recited in claim 5, wherein the cover has a cut plane parallel to a back-side surface of the body.

8. A portable electronic device comprising:
a body with a headset storage portion located therein and an opening exposing the headset storage portion; and
a wireless headset attached to the body, configured to fit in the headset storage portion and covering the opening, including:
a primary portion with a inlet opening located thereon; and
an earplug portion coupled pivotally with the primary portion,
having an outlet opening and a cover located thereon,
wherein the headset storage portion and the opening are located on a corner formed by a back-side surface and a bottom-side surface on the body and the headset storage portion is configured to allow the wireless headset be detached from the body through the opening,
wherein the headset storage portion includes a first cavity for containing the primary portion and a second cavity for containing the earplug portion, and
wherein the first cavity has a first long-axis direction parallel to the back-side surface and the second cavity has a second long-axis direction parallel to the back-side surface.

9. A portable electronic device comprising:
a body with a headset storage portion located therein and an opening exposing the headset storage portion; and
a wireless headset attached to the body, configured to fit in the headset storage portion and covering the opening,
wherein the headset storage portion and the opening are located on a corner formed by a front-side surface and a bottom-side surface on the body and the headset storage portion is configured to allow the wireless headset be detached from the body through the opening, and
wherein the wireless headset comprises:
a primary portion with a second inlet opening located on a second front-side surface coupled with the front-side surface; and
an earplug portion with a outlet opening located thereon, coupled pivotally with the primary portion.

10. A portable electronic device as recited in claim 9, wherein the headset storage portion comprises:
a first cavity for containing the primary portion; and
a second cavity for containing the earplug portion.

11. A portable electronic device as recited in claim 10, wherein the first cavity has a first long-axis direction parallel to the front-side surface; the second cavity has a second long-axis direction parallel to the front-side surface.

12. A portable electronic device as recited in claim 9, wherein the earplug portion has a cover located thereon.

13. A portable electronic device as recited in claim 12, wherein the cover is made of soft rubber.

14. A portable electronic device as recited in claim 12, wherein the cover has a cut plane parallel to the front-side surface of the body.
